(19) United States
(12) Patent Application Publication
(10) Pub. No.: US 2011/0121045 A1
(43) Pub. Date: May 26, 2011

(54) TRUCK TOOL BOX ORGANIZER

(76) Inventor: Robert Agerton, Ponce de Leon, FL (US)

(21) Appl. No.: 12/951,874

(22) Filed: Nov. 22, 2010

Related U.S. Application Data
(60) Provisional application No. 61/263,370, filed on Nov. 21, 2009.

(51) Int. Cl. B60R 11/00

(52) U.S. Cl. 224/546

(57) ABSTRACT

A tool organizer comprises a rectangular plate having a raised frame extending thereabout. A rectangular pad is sized to fit against the rectangular plate within the raised frame. The rectangular pad has a plurality of spaced apart matching tool cutouts therealong. A plurality of hook and loop fastener tabs are secured between the rectangular plate and the rectangular pad to maintain the rectangular pad to the rectangular plate. A plurality of double sided adhesive tape strips are provided with each placed through one tool cutout in the rectangular pad and against the rectangular plate to hold a tool thereto. A mechanism is for retaining in a removable manner each tool within the matching tool cutout in the rectangular pad.

### CROSS-REFERENCE TO RELATED APPLICATION

This application claims the benefit of Provisional Patent Application No. 61/263,370, filed on Nov. 21, 2009, in the United States Patent & Trademark Office, the disclosure of which is incorporated herein by reference.

### BACKGROUND OF THE INVENTION

1. Field of the Invention

The present invention relates to a tool holder, and more particularly, a tool organizer.

The tool organizer provides easy access to the most commonly used tools. The present invention can be used on single and double lid boxes, as well as small side boxes. The tool organizer is ideal for truck and job site toolboxes. It can also be secured to shop walls if necessary. The present invention can be made to accommodate different professions, such as carpenters, electricians, plumbers, and more. The tool organizer provides convenience by ensuring that an individual's tools are ready and accessible.

2. Description of the Prior Art

Many individuals use their tools everyday in their profession. Some keep their toolboxes in their truck bed, while some carry it into the job site. Others hang their tools in their shop. Regardless of where the tools are stored, many individuals find themselves searching through their toolbox looking for a specific item. Digging through the toolbox can be frustrating and time-consuming.

Numerous innovations for item storage containers have been provided in the prior art that will be described. Even though these innovations may be suitable for the specific individual purposes to which they address, however, they differ from the present invention.

A FIRST EXAMPLE, U.S. Pat. No. 4,836,374, issued on Jun. 6, 1989, to Hutchins et al. teaches an attractive fabric covered fitted tool case which includes a pair of platform members each having a multiplicity of pockets in their top wall to receive a multiplicity of tools, and relatively rigid support members under the platform members to provide structural support therefore. An elongated base sheet underlies the platform members and extends therebetween to provide a spacer section about which the platform members may be folded into abutting relationship in the closed position of the case. A fabric cover is provided on the outer surface of the base sheet and a releasable closure secures the tool case in closed position. The tool case may additionally include one or more pockets on its principal faces, and one of the pockets may include a pair of hanging rings which are pivotally mounted within a pocket so as to be able to be pivoted from a concealed position within the pocket to an exposed position for hanging the tool case.

A SECOND EXAMPLE, U.S. Pat. No. 4,967,944, issued on Nov. 6, 1990, to Waters teaches a nonmetallic container adapted for use as a tool or utility box in a pickup truck which is preferably unitarily constructed of linear high-density polyethylene and is adapted to fit both standard and compact pickup trucks.

A THIRD EXAMPLE, U.S. Pat. No. 5,320,223, issued on Jun. 14, 1994, to Allen teaches an insert for a tool box drawer or the like that has a first lower layer of compressible material such as foam above which is a second upper layer of compressible material. The second upper layer of compressible material has a plurality of cut outs therein, each cut out being in the shape of the silhouette of the item or tool to be retained therein. A film of material is bonded between the first layer of compressible material and the second layer of compressible material such that the cut out portions become pockets. Labels are provided at the bottom of each pocket by printing information on either the first layer of compressible material or on the film with the printing positioned so as to be visible through the cut out portions of the upper second layer of compressible material. Where the lower layer of compressible material is non-porous, the film is not required.

A FOURTH EXAMPLE, U.S. Pat. No. 5,409,560, issued on Apr. 25, 1995, to Hammer et al. teach a method of making liners for tool boxes that provides custom formed liners to fit a specific selection and arrangement of tools in a tool chest, box or drawer. The method comprises first cutting a backing sheet and a tool receptacle sheet to fit the selected tool drawer or container, and laminating the receptacle sheet to the underlying backing sheet. The selected tools are then laid out on top of the receptacle sheet according to the pattern desired and their outlines traced on the top of the receptacle sheet. The tool receptacles are then cut through the receptacle sheet, down to but not through the underlying backing sheet, along the traced lines. A liquid plastic or vinyl material may be added to the bottoms of the completed receptacles if desired, and allowed to cure to further cushion any tools placed therein. The liquid plastic material may be provided in different colors to assist in the proper placement of tools and in the determination of missing tools. The backing sheet is preferably somewhat stiffer and firmer than the receptacle sheet, and may be formed of wood, plastic, rubber, or metal, as desired. The receptacle sheet may be formed of any suitable resilient material; preferably a closed cell foam material is used. The receptacles may be die cut for production purposes if desired.

A FIFTH EXAMPLE, U.S. Pat. No. 5,518,158, issued on May 21, 1996, to Matlack teaches a tailgate toolbox assembly for a pickup truck which includes a toolbox having an attachment member mounted on an inner side of the pickup tailgate and a tool storage compartment pivotally hinged to the attachment member. The attachment member and tool storage compartment both extend substantially the length of the tailgate. The toolbox also has supports extending between the tool storage compartment and the attachment member at each end of the tailgate. The tailgate toolbox assembly further includes a rigid cover, such as a tread plate, for the toolbox. The tread cover plate is shaped to protect the toolbox and to permit mobile equipment to be loaded and unloaded thereover onto the pickup bed. The toolbox assembly being attached to the tailgate and in a closed position can be moved downward until horizontal and the tool storage compartment can then be pivoted upward until vertical to reveal tools stored therein. In the horizontal open usage position the attachment member being in the form of a flat sheet provides a workbench with the tools being readily accessible thereabove.

A SIXTH EXAMPLE, U.S. Pat. No. 6,077,007, Issued on Jun. 20, 2000, to Porter et al. teach a pickup truck bed organizer and method that comprises tubular elements designed to slip into one another so as to be adjustable in length for mating to virtually all models of pickup trucks. Four, five, and six-way connectors include multiple tubular plugs extending therefrom. Leg members that telescopingly interconnect with the tubular plugs can be combined with the connectors to form a wide variety of different frames for the organizer as desired by the pickup truck operator. Locking members are provided for locking/unlocking the frame of the organizer in the selected configuration. The locking members are operable without the need for tools so that the organizer can be installed and uninstalled without the need for tools. One of many benefits/methods of the organizer is the ability to load cargo in the pickup truck bed directly over the rear wheels so as to use the cargo to increase traction of the pickup truck. Rubber feet are utilized on the feet and arms so as to protect the pickup bed. The system is adjustable and can be added to and taken apart as the need arises.

A SEVENTH EXAMPLE, U.S. Pat. No. 6,267,277, issued on Jul. 31, 2001, to Taylor teaches in accordance with the first embodiment of the invention a portable, flexible tool holder having a generally rectangular flexible body, the body having an inner surface and an outer surface and an upper edge, a lower edge and two side edges, the outer surface having a plurality of magnets connected thereto, the inner surface having a plurality of pockets an loops thereon for holding tools and equipment, either of the side edges being foldable toward the other of the side edges to enclose the inner surface of the body inside the outer surface of the body to tightly hold tools and equipment within the tool holder, and the upper edge having receivers for attaching a carrying device to the tool holder. In accordance with a second embodiment of the invention there is provided a portable tool holder having a generally rectangular body, the body having an inner surface and an outer surface, the outer surface having a plurality of magnets connected thereto, the inner surface having a pocket for holding welding rods and a strap assembly located beneath on the lower end of the pocket for holding tools and equipment, and the upper edge having a receiver for attaching a carrying device to the tool holder.

AN EIGHTH EXAMPLE, U.S. Pat. No. 6,632,162, issued on Oct. 14, 2003, to Wilkenson teaches a method for making recessed tray liners for storing objects in a storage container. The first step in the method is to size a structural thermoplastic foam liner to fit within a tray. The foam liner is preferably a foamed polyethylene plastic. After the tray is lined with the foam liner, the object or objects to be held in the tray are then heated to a temperature sufficient to soften the thermoplastic foam. The temperature of the heated object is selected to be above the softening temperature of the thermoplastic foam, but below the melting temperature of the foam. After the object or objects have reached the appropriate temperature, the heated object is pressed into the foam lining to form a cavity. The heated foam will flow such that the cavity will conform to the contours of the object being pressed into the foam. After the object is sufficiently pressed into the foam, it is rapidly cooled to a temperature below the softening temperature of the foam. Preferably, the cooling is achieved by quenching the object with a fluid having a temperature lower than the softening temperature of the foam. Water is a suitable cooling fluid.

A NINTH EXAMPLE, U.S. Patent Office Publication No. 2004/0158968, published on Aug. 19, 2004, to Jones et al. teach an improved truck bed toolbox lid and a method of producing the same. The truck bed toolbox lid includes an outer metallic sheet layer comprising a generally rectangular top sheet member, a longitudinal front edge member, two lateral edge members and a longitudinal rear edge member. A metallic liner sheet member is disposed inside the top sheet member in edge contact abutment with beveled inside edges of the front and rear longitudinal edge members and the lateral edge members to create an internal cavity in which the liner is by stitch welding. One or more injection ports are provided through the liner sheet member through which a self-expanding and self-curing, relatively high-density, foam is injected. The stitch welded edge contacts leave non-welded, gas permeable junctions along the wedged cavity periphery at a funneled apex of the edge contacted boundary which facilitate expansion of the foam toward the outermost edges of the cavity.

A TENTH EXAMPLE, U.S. Pat. No. 6,945,546, issued on Sep. 20, 2005, to Guirlinger teach a tool organizer. According to one embodiment, the tool organizer comprises a frame and a plurality of wheels attached to the frame. The tool organizer also includes a tool storage structure supported by the frame. The tool storage structure comprising a plurality of storage panels, each storage panel comprises at least one tool fastener and associated tool indicia for securing and identifying a specific tool. The plurality of storage panels are movable with respect to one another between a closed configuration and an open configuration. A modular tool organizer, a tool set transportation system, a tool bag and a method for inspecting a set of tools stored within a tool organizer are also disclosed.

AN ELEVENTH EXAMPLE, U.S. Patent Office Publication No. 2006/0000788, published on Jan. 5, 2006, to Sholem teaches a tool organizer system which has a flat sheet of magnetically attracted material that attracts magnets attached to tools to support the tools on the flat sheet. The system includes position indicators that can be attached at any orientation and position on the flat sheet. The system can be provided as a kit with one or more components. A method of organizing a set of tools provides for efficient use of space and clear association between a tool and a previously selected position and avoids loss of tools by placing them in previously selected positions. A method of making a tool organizer system includes making the system in accordance with requests from a customer. The tool organizer system includes a kitchen tool organizer system that has a container with at least one magnetically attractive side and a handle, allowing the container to retain kitchen tools within the container and magnetically on the side. Attachment tools may include a fastener attachment tool that couples to a tool and provides magnetic force and a magnetic bar coupled to a tool organizer to allow metal tools to be coupled to the bar.

A TWELFTH EXAMPLE, U.S. Patent Office Publication No. 2009/0071854, published on Mar. 19, 2009, to Martin teaches an inventory control system and a method of manufacturing an item storage receptacle for the system. The item storage receptacle has a plurality of individually-shaped recess for receiving specific inventory items. The storage receptacle may also have a monitoring feature for attaching a monitoring device configured to generate a signal for the system indicating whether the tool is present.

It is apparent now that numerous innovations for item storage containers have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a tool organizer that avoids the disadvantages of the prior art.

ANOTHER OBJECT of the present invention is to provide a tool organizer that is simple and inexpensive to manufacture.

STILL ANOTHER OBJECT of the present invention is to provide a tool organizer that is simple to use.

BRIEFLY STATED, STILL YET ANOTHER OBJECT of the present invention is to provide a tool organizer which comprises a rectangular plate having a raised frame extending thereabout. A rectangular pad is sized to fit against the rectangular plate within the raised frame. The rectangular pad has a plurality of spaced apart tool cutouts therealong. A plurality of hook and loop fastener tabs are secured between the rectangular plate and the rectangular pad to maintain the rectangular pad to the rectangular plate. A plurality of double sided adhesive tape strips are provided with each placed through one tool cutout in the rectangular pad and against the rectangular plate to hold a tool thereto. A mechanism is for retaining in a removable manner each tool within a matching tool cutout in the rectangular pad.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a front elevational view of the present invention mounted to a wall;

FIG. 2 is a perspective view, showing the present invention mounted to the underside of the lid of a crossover toolbox in a bed of a pickup truck; and

FIG. 3 is a front view, taken in the direction of arrow 3 in FIG. 2.

### REFERENCE NUMERALS UTILIZED IN THE DRAWING

110 tool organizer
112 rectangular plate of tool organizer 110
114 raised frame of rectangular plate 112
116 rectangular pad of tool organizer 110
118 tool cutout in rectangular pad 116
120 hook and loop fastener tabs of tool organizer 110
122 double sided adhesive tape strip of tool organizer 110
124 tool
126 retaining mechanism of tool organizer 110
128 first strap of retaining mechanism 126
130 second strap of retaining mechanism 126
132 hook fastener end of first strap 128
134 loop fastener end of second strap 130
136 self-tapping screw of retaining mechanism 126
138 upper long portion of raised frame 114
140 lower long portion of raised frame 114
142 mounting mechanism of tool organizer 110
144 flat support surface
146 lid for flat support surface 144
148 crossover toolbox
150 bed of pickup truck 152
152 a pickup truck
153 wall for flat support surface 144
154 self-tapping screw of mounting mechanism 142
156 aluminum metal of rectangular plate 112 with raised frame 114
158 foam rubber material of rectangular pad 116

### DETAILED DESCRIPTION OF THE PREFERRED EMBODIMENT

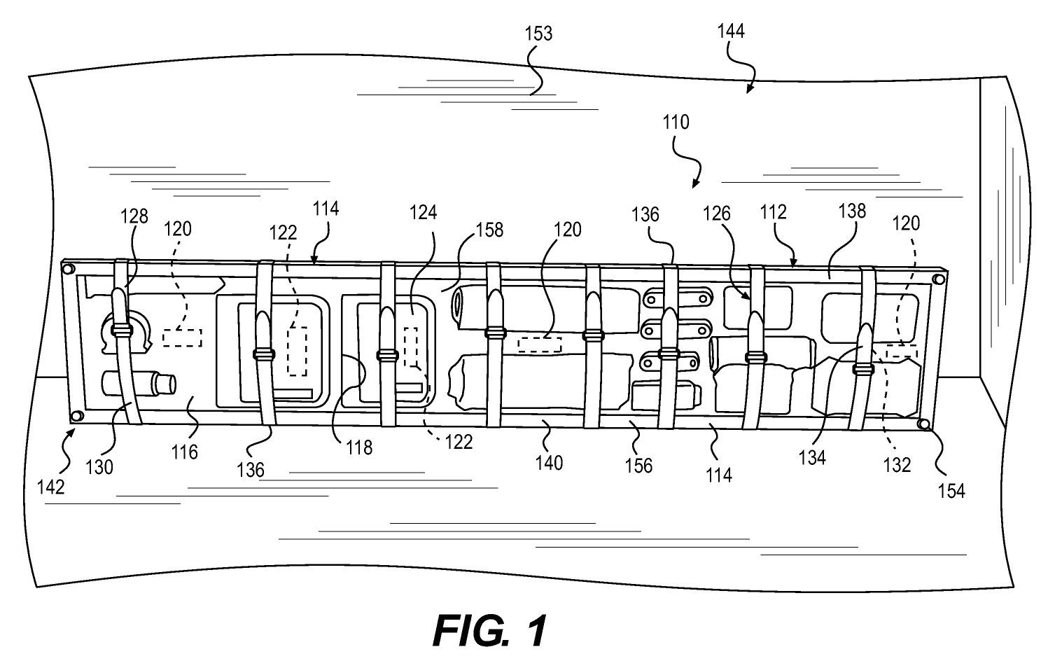

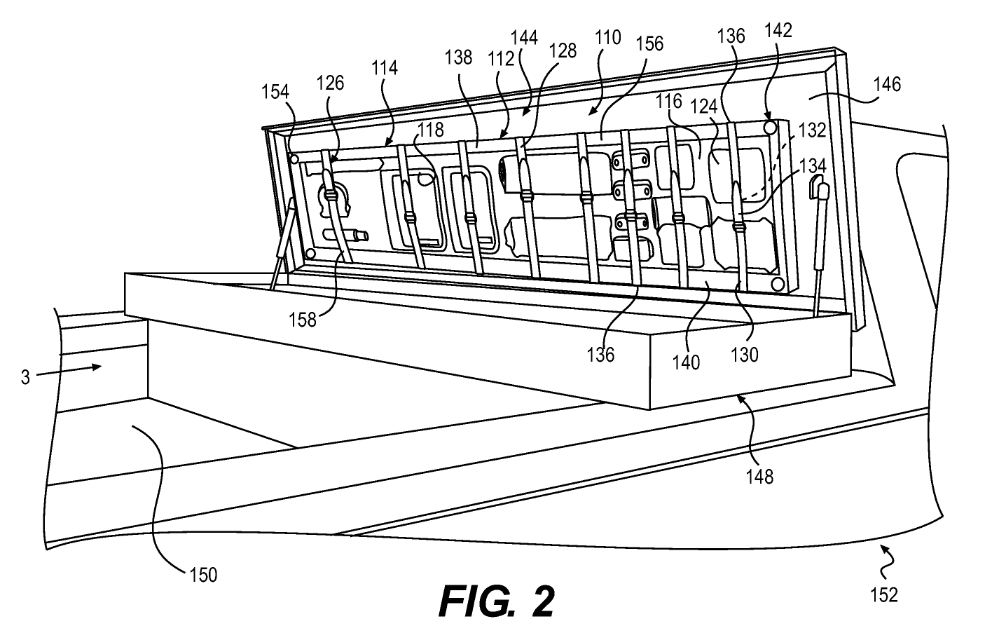

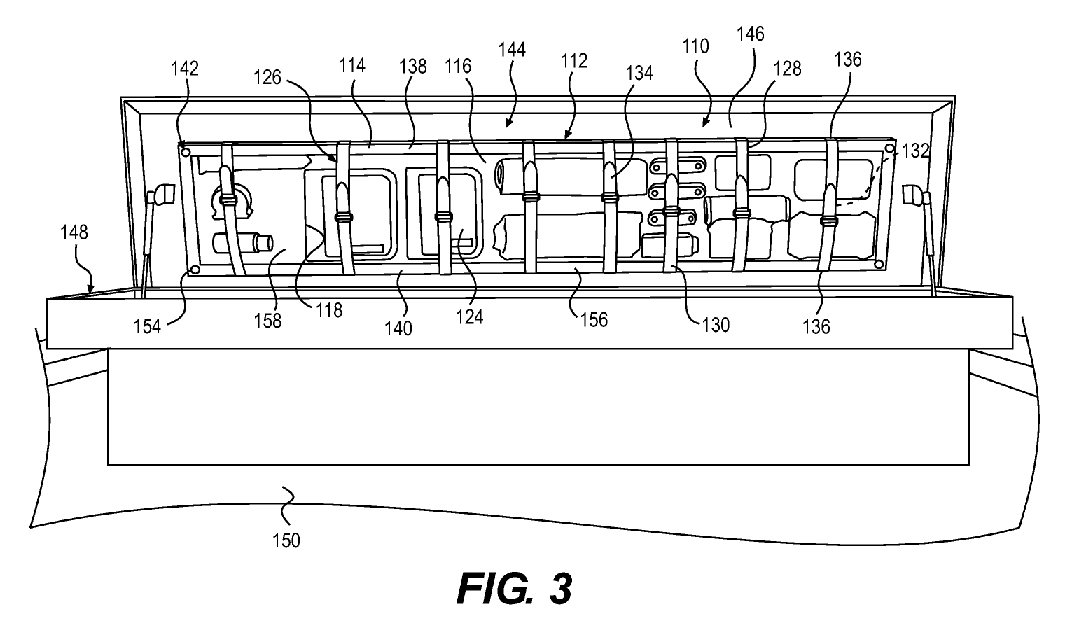

Referring now to the figures, in which like numerals indicate like parts, and particularly to FIGS. 1 through 3, and as such, will be discussed with reference thereto.

The present invention is a tool organizer 110 which comprises a rectangular plate 112 having a raised frame 114 extending thereabout. A rectangular pad 116 is sized to fit against the rectangular plate 112 within the raised frame 114. The rectangular pad 116 has a plurality of spaced apart tool cutouts 118 therealong. A plurality of hook and loop fastener tabs 120 are secured between the rectangular plate 112 and the rectangular pad 116 to maintain the rectangular pad 116 to the rectangular plate 112. A plurality of double sided adhesive tape strips 122 are provided with each placed through one tool cutout 118 in the rectangular pad 116 and against the rectangular plate 112 to hold a tool 124 thereto. A mechanism 126 is for retaining in a removable manner each tool 124 within a matching tool cutout 118 in the rectangular pad 116.

Each retaining mechanism 126 comprises two straps 128, 130 having overlapping hook and loop fastener ends 132, 134. Two self-tapping screws 136 are for securing a free end of each strap 128, 130 to upper and lower long portions 138, 140 of the raised frame 114 of the rectangular plate 112.

The tool organizer 110 further comprises a mechanism 142 for mounting the rectangular plate 112 to a flat support surface 144, such as the underside of a lid 146 of a crossover tool box 148 in a bed 150 of a pickup truck 152 or a wall 153. The mounting mechanism 142 comprises a plurality of self-tapping screws 154 extending through the raised frame 114 of the rectangular plate 112 and into the flat support surface 144.

The rectangular plate 112 with the raised frame 114 is comprised out of aluminum metal 156. The rectangular pad 116 is comprised out of a foam rubber material 158 being approximately one inch in thickness.

The main function of the tool box organizer 110 is to assist in keeping the crossover toolbox 148 organized. To construct the tool organizer 110 a person takes the rectangular pad 116 and lays it out on a shop table. The person then positions the tools 124 in the proper location on the rectangular pad 116. It is recommended to use lightweight tools 124 that are no more than one and a half inches in thickness. The tools 124 are placed in spaced apart positions and be approximately one and a half inches in from the edge of the rectangular pad 116. There should be about a one inch space between each tool 124. The person will then trace around the tools 124 with a black permanent marker. Once the tools 124 have been traced, the person cuts around the outline of each tool 124 in the rectangular pad 116 to form each tool cutout 118. It is recommended to use a razor knife or heat gun for this task. The rectangular pad 116 is then placed inside the raised frame 114 of the rectangular plate 112. The tools 124 are placed in the matching tool cutouts 118. The straps 128, 130 with the hook and loop fastener ends 132, 134 are fastened to the upper and lower portions 138, 140 of the raised frame 114 using the self-tapping screws 136, so that the straps 128, 130 will extend over and retain the tools 124 to the rectangular pad 112. It is recommended to pre-drill holes in the raised frame 114 before screwing in the self-tapping screws 136. Once the straps 128, 130 are in place, the person will remove the tools 124 and rectangular pad 116 from the rectangular plate 112. The raised frame 114 may then be centered on the underside of the lid 146 of the crossover toolbox 148. Using the self-tapping screws 154, the raised frame 114 will be fastened to the underside of the lid 146. The rectangular pad 116 is then placed back inside the raised frame 114 with the hook and loop fastener tabs 120 located between the rectangular plate 112 and the rectangular pad 116. Each double sided adhesive tape strip 122 is placed between the back of each tool 118 and the rectangular plate 112 to hold the tools 118 in place and keep them from shifting. Then the straps 128, 130 are secured over each tool 124. The lid 146 of the crossover toolbox 148 can then be closed in a normal manner. The tool organizer 110 is available in a variety of sizes and may also be adapted for use on the wall 153 such as in a work shop. The exact specifications may vary.

It will be understood that each of the elements described above, or two or more together, may also find a useful application in other types of constructions differing from the types described above.

While the invention has been illustrated and described as embodiments of a tool organizer, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

What is claimed is:

1. A truck tool box organizer which comprises:
a) a rectangular plate having a raised frame extending thereabout;
b) a rectangular pad sized to fit against the rectangular plate within the raised frame, the rectangular pad having a plurality of spaced apart matching tool cutouts for tools therealong;
c) a plurality of hook and loop fastener tabs secured between the rectangular plate and the rectangular pad to maintain the rectangular pad to the rectangular plate;
d) a plurality of double sided adhesive tape strips, each placed through one the tool cutout in the rectangular pad and against the rectangular plate to hold a tool thereto; and
e) means for retaining in a removable manner each tool within the matching tool cutout in the rectangular pad.

2. The tool organizer as recited in claim 1, wherein the retaining means comprises:
a) two straps having overlapping hook and loop fastener ends; and
b) two self-tapping screws for securing a free end of each the strap to upper and lower long portions of the raised frame of the rectangular plate.

3. The tool organizer as recited in claim 2, further comprising means for mounting the rectangular plate to a flat support surface.

4. The tool organizer as recited in claim 3, wherein the mounting means comprises a plurality of self-tapping screws extending through the raised frame of the rectangular plate and into the flat support surface.

5. The tool organizer as recited in claim 1, wherein the rectangular plate with the raised frame is comprised out of aluminum metal.

6. The tool organizer as recited in claim 1, wherein the rectangular pad is comprised out of foam rubber material being approximately one inch in thickness.

7. The tool organizer as recited in claim 1, wherein the cutouts are formed by tracing around the tools with a black permanent marker and then cut the outline of each tool with a razor knife.

8. The tool organizer as recited in claim 1, wherein the cutouts are formed by tracing around the tools with a black permanent marker and then cut the outline of each tool with a heat gun.

9. The tool organizer as recited in claim 1, wherein the cutouts are one inch spaced apart.

10. The tool organizer as recited in claim 1, wherein the tools are placed in spaced apart positions and be approximately one and a half inches in from the edge of the rectangular pad.

11. The tool organizer as recited in claim 1, wherein the tools are about a one inch space between each tool.
